(19) United States
(12) Patent Application Publication
(10) Pub. No.: US 2022/0106457 A1
(43) Pub. Date: Apr. 7, 2022

(54) POLY(ARYLENE SULPHIDE) COMPOSITION HAVING HIGH DIELECTRIC PERFORMANCE

(71) Applicant: SOLVAY SPECIALTY POLYMERS USA, LLC, Alpharetta, GA (US)

(72) Inventors: Paveena CALLOZZO, Woodstock, GA (US); Vijay GOPALAKRISHNAN, Dunwoody, GA (US); Raleigh L. DAVIS, Suwanee, GA (US)

(21) Appl. No.: 17/426,644

(22) PCT Filed: Feb. 25, 2020
(86) PCT No.: PCT/EP2020/054912

§ 371 Date: Jul. 29, 2021

Related U.S. Application Data
(60) Provisional application No. 62/811,094, filed on Feb. 27, 2019.

(30) Foreign Application Priority Data
Sep. 23, 2019 (EP) 19199011.8

(51) Int. Cl. C08K 7/14; C08K 3/38; C08K 3/34

(52) U.S. Cl. CPC C08K 7/14; C08K 3/38; C08K 2201/005; C08K 2003/385; C08K 3/346

(57) ABSTRACT

The invention pertains to a composition (C) comprising a poly(arylene sulphide) polymer, at least one flat glass fiber and at least one of boron nitride and talc, and to a 5G base station component incorporating said composition (C).

### RELATED APPLICATIONS

This application claims priority to U.S. provisional application 62/811,094 filed on Feb. 27, 2019 and to European patent application EP 19199011.8 filed on Sep. 23, 2019, the whole content of these applications being incorporated herein by reference for all purposes.

### TECHNICAL FIELD

The present invention relates to a poly(arylene sulphide) composition, in particular to a poly(arylene sulphide) composition having high dielectric performance. The invention further relates to a fifth generation (5G) base station component incorporating said poly(arylene sulphide) composition, in particular to a 5G base station antenna housing incorporating said poly(arylene sulphide) composition.

### BACKGROUND ART

Fifth generation (5G) wireless systems represent the next mobile telecommunication standard beyond the current telecommunication standard of forth generation (4G).

5G standard enables higher capacity, higher data rates and higher signal sensitivity than current 4G standard, thus allowing higher density of connected devices per unit area and consumption of higher or unlimited data quantities.

As the number of mobile users and their demand for data rises, 5G base stations must be able to handle far more traffic at much higher speeds than base stations that make up current 4G cellular networks. To this purpose, 5G base stations should be able to support many more antennas than 4G base stations; this technology is called massive multiple-input multiple-output (MIMO) and would allow 5G base stations to send and receive signals from many more users at once, thus increasing the capacity of mobile networks.

Need is therefore felt for materials which are suitable for the development of 5G base stations and in particular to 5G base stations antennas, namely materials having satisfactory dielectric properties in terms of dielectric constant and, most significantly, in terms of dissipation factor; low coefficient of linear thermal expansion; low shrinkage and good mechanical properties.

Compositions comprising a poly(phenylene sulphide), a ceramic material like strontium titanate, barium neodymium titanate and barium strontium titanate/magnesium zirconate and a reinforcing filler like glass fibers are known from WO 97/20324 as materials having good dielectric properties, but at the expense of mechanical properties like strength and ductility. Therefore, said properties are not satisfactory for application in 5G base stations.

### SUMMARY OF INVENTION

In a first aspect, the present invention relates to a composition [composition (C)] comprising:
a poly(arylene sulphide) polymer;
at least one flat glass fiber;
at least one of boron nitride and talc.

In another aspect, the present invention relates to a 5G base station component comprising the above composition (C).

The Applicant has surprisingly found that the composition (C) according to the invention shows excellent dielectric performances and significantly reduced shrinkage and CLTE, while having excellent mechanical properties such as strength and ductility, and reduced internal stresses.

### DETAILED DESCRIPTION OF THE INVENTION

In the present description, unless otherwise indicated, the following terms are to be meant as follows.

“Dk” refers to the dielectric constant.

“Df” refers to the dissipation factor.

“CLTE” refers to the coefficient of linear thermal expansion.

“Shrinkage anisotropy” denotes the difference in shrinkage in the flow direction and the transverse direction.

The “dielectric constant” refers to the ability of a material to interact with the electromagnetic radiation and, correspondingly, disrupt electromagnetic signals travelling through the material. Accordingly, the lower the dielectric constant of a material at a given frequency, the less the material disrupts the electromagnetic signal at that frequency.

The “dissipation factor” is the measurement of the dielectric loss in a material. Accordingly, the lower the dissipation factor, the lower the dielectric loss to the material.

As said, the composition (C) according to the invention comprise a poly(arylene sulphide) polymer, at least one flat glass fiber and at least one of boron nitride and talc.

According to a preferred embodiment, said composition (C) consists or consists essentially of a poly(arylene sulphide) polymer, at least one flat glass fiber and at least one of boron nitride and talc. The expression “consists essentially of” is intended to denote that the composition (C) comprises a poly(arylene sulphide) polymer, at least one flat glass fiber and at least one of boron nitride and talc, and no more than 10 wt. %, preferably no more than 5 wt. %, more preferably no more than 3 wt. %, even more preferably no more than 1 wt. %, of other components.

### Poly(Arylene Sulphide) Polymer

A poly(arylene sulphide) polymer comprises recurring units (R_{PAS}) of formula —(Ar—S)— as the main structural units, preferably in an amount of at least 80% (mol), wherein Ar is an aromatic group. Examples of Ar include groups of formulas (I-A) to (I-K) given below:

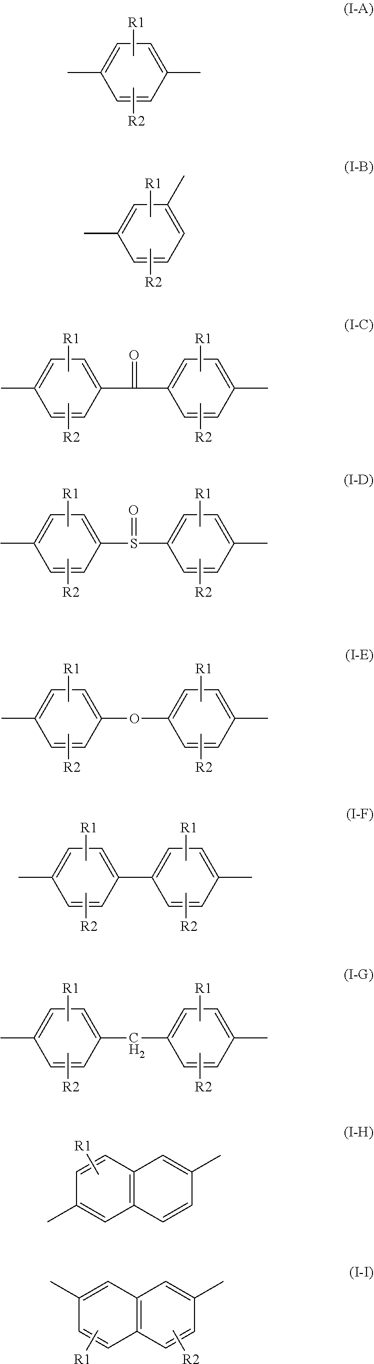

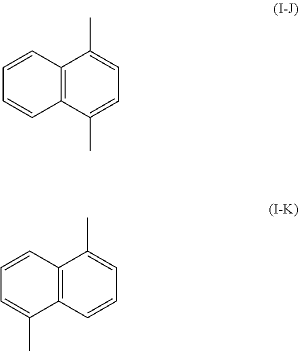

wherein R1 and R2, equal or different from each other, are independently selected among hydrogen atoms, alkyl of 1 to 12 carbon atoms, alkoxy of 1 to 12 carbon atoms, arylene of 6 to 24 carbon atoms, and halogens.

Said poly(arylene sulphide) polymer preferably comprises recurring units (R_{PAS}) in which Ar is a group of formula (I-A), more preferably in which R1 and R2 are hydrogen atoms. Accordingly, said poly(arylene sulphide) polymer is preferably a poly(phenylene sulphide), which is notably commercially available as RYTON® PPS from Solvay Specialty Polymers USA, L.L.C.

In some embodiments, the composition (C) includes a plurality of distinct poly(arylene sulphide) polymers, each poly(arylene sulphide) polymer having a distinct recurring unit (R_{PAS}).

Said composition (C) comprises said poly(arylene sulphide) polymer in a concentration preferably of at least 30 wt. %, more preferably of at least 35%, even more preferably of at least 40 wt. %, and preferably of at most 80 wt. %, more preferably of at most 70 wt. %, even more preferably of at most 65 wt. % with respect to the total weight of the composition (C).

### Flat Glass Fiber

As used herein, a flat glass fiber has a non-circular cross section. The cross-section is taken in a plane perpendicular to the length of the glass fiber and has a major dimension, which corresponds to the longest dimension in the cross section, and a minor dimension, which is perpendicular to both the major dimension and the length of the glass fiber. The non-circular cross section can be, but is not limited to, oval, elliptical or rectangular.

The major dimension is preferably at least 15 μm, more preferably at least 20 μm, even more preferably at least 22 μm, most preferably at least 25 μm. The major dimension is preferably at most 40 μm, more preferably at most 35 μm, even more preferably at most 32 μm, most preferably at most 30 μm. In some embodiments, the major dimension ranges from 15 to 35 μm, preferably from 20 to 30 μm, more preferably from 25 to 29 μm.

The minor dimension is preferably at least 4 μm, more preferably at least 5 μm, even more preferably at least 6 μm, most preferably at least 7 μm. The minor dimension is preferably at most 25 μm, more preferably at most 20 μm, even more preferably at most 17 μm, most preferably at most 15 μm. In some embodiments, the minor dimension ranges from 5 to 20, preferably from 5 to 15 μm, more preferably from 7 to 11 μm.

Said at least one flat glass fiber has an aspect ratio preferably of at least 2, more preferably of at least 2.2, even more preferably of at least 2.4, most preferably of at least 3. Said at least one flat glass fiber has an aspect ratio preferably of at most 8, more preferably of at most 6, even more preferably of at most 4. In some embodiments, Said at least one flat glass fiber has an aspect ratio ranging from 2 to 6, preferably from 2.2 to 4. The aspect ratio is defined as a ratio of the major dimension to the minor dimension of said at least one flat glass fiber. The aspect ratio can be measured according to ISO 1888.

In some embodiments, said at least one flat glass fiber is a flat E-glass fiber. Said flat E-glass fiber has a Dk at 2.4 GHz preferably ranging from 6.0 to 7.0, more preferably of about 6.5. Said flat E-glass fiber has a Df at 2.4 GHz preferably ranging from 0.003 to 0.004.

In other embodiments, said at least one flat glass fiber is a flat D-glass fiber, namely a low-dielectric glass fiber. Said flat D-glass fiber has a Dk at 2.4 GHz preferably ranging from 4.0 to 5.0, more preferably of about 4.5. Said flat D-glass fiber has a Df at 2.4 GHz preferably not greater than 0.003, more preferably of about 0.001.

In a first embodiment, said composition (C) comprises flat E-glass fibers. In a second embodiment, said composition (C) comprises flat D-glass fibers. In a further embodiment, said composition (C) comprises a mixture of flat E-glass fibers and flat D-glass fibers.

In some embodiments, said flat D-glass fiber comprises the following components in the following concentrations:

TABLE 1

| Component | Concentration (wt. %) |
|---|---|
| SiO₂ | 50 to 76 |
| B₂O₃ | 8 to 30 |
| Al₂O₃ | 0 to 18 |
| TiO₂ | 0 to 5 |
| MgO | 0 to 10 |
| CaO | 0 to 8 |
| ZnO | 0 to 3 |
| Li₂O | 0 to 1.1 |
| Na₂O | 0 to 2 |
| K₂O | 0 to 2 |
| Fe₂O | 0 to 0.4 |
| F₂ | 0 to 2 |

The concentrations in Table 1 are relative to the total weight of the flat D-glass fiber. In some embodiments, the selected concentrations sum to 100 wt. %.

In some embodiments, said flat D-glass fiber has a tensile strength ranging from 1000 MPa to 5000 MPa, preferably from 2000 MPa to 2500 MPa. Additionally or alternatively, said flat D-glass fiber has a tensile modulus ranging from 20 GPa to 90 GPa, preferably from 50 GPa to 60 GPa. Tensile strength and tensile modulus can be measured according to ASTM D2343.

Said composition (C) comprises said at least one flat glass fiber in a concentration preferably of at least 10 wt. %, more preferably of at least 20 wt. %, even more preferably of at least 25 wt. %, most preferably of at least 30 wt. %, and preferably of at most 50 wt. %, more preferably of at most 45 wt. %, even more preferably of at most 40 wt. % with respect to the total weight of the composition (C). In some embodiments, the concentration of said at least one flat glass fiber is from 10 wt. % to 50 wt. %, preferably from 20 wt. % to 45 wt. %, more preferably from 35 wt. % to 45 wt. %.

### Boron Nitride or Talc

The median particle size of boron nitride is preferably at least 0.05 μm, more preferably at least 0.1 μm, even more preferably at least 0.2 μm, most preferably at least 1 μm. The average particle size of boron nitride is preferably at most 30 μm, more preferably at most 20 μm, even more preferably at most 18 μm, most preferably at most 10 μm. The average particle size of boron nitride is preferably from 1 μm to 20 μm, more preferably from 2 μm to 18 μm, even more preferably from 2 μm to 10 μm.

The median particle size of talc is preferably at least 0.05 μm, more preferably at least 0.1 μm, even more preferably at least 0.2 μm, most preferably at least 1 μm. The average particle size of talc is preferably at most 30 μm, more preferably at most 20 μm, even more preferably at most 18 μm, most preferably at most 10 μm. The average particle size of talc is preferably from 1 μm to 20 μm, more preferably from 2 μm to 18 μm, even more preferably from 2 μm to 10 μm.

The median particle size of boron nitride and talc is measured via light scattering techniques (dynamic or laser) using the respective equipment coming for example from the company Malvern (Mastersizer Micro or 3000) or using screen analysis according to DIN 53196.

Boron nitride and talc with a median particle size in the above identified ranges provide better mechanical properties and more homogeneous spatial response to a dielectric field.

Said composition (C) comprises at least one of boron nitride and talc in a concentration preferably of at least 5 wt. %, more preferably of at least 7 wt. %, even more preferably of at least 10 wt. %, and preferably of at most 30 wt. %, more preferably at most 20 wt. %, even more preferably at most 15 wt. % with respect to the total weight of the composition (C). In some embodiments, the concentration of said at least one of boron nitride and talc is from 5 wt. % to 30 wt. %, preferably from 7 wt. % to 25 wt. %, more preferably from 10 wt. % to 20 wt. %, even more preferably around 15 wt. %. The expression “at least one of boron nitride and talc” is intended to denote that said composition, according to various embodiments, may comprise boron nitride in the above defined concentration, or talc in the above defined concentration, or a mixture of boron nitride and talc in the above defined concentration.

According to a preferred embodiment, said composition (C) comprises boron nitride in a concentration of at least 5 wt. %, more preferably of at least 7 wt. %, even more preferably of at least 10 wt. %, and preferably of at most 30 wt. %, more preferably at most 20 wt. %, even more preferably at most 15 wt. % with respect to the total weight of the composition (C). In some embodiments, the concentration of boron nitride is from 5 wt. % to 30 wt. %, preferably from 7 wt. % to 25 wt. %, more preferably from 10 wt. % to 20 wt. %, even more preferably around 15 wt. %.

### Composition (C)

It was surprisingly found that the composition (C) shows excellent dielectric properties, in particular low Df.

Said composition (C) also shows low shrinkage anisotropy and low CLTE in the flow direction and the transverse direction.

Additionally, the composition (C) has excellent mechanical properties, including tensile stress at break, tensile strain at break, tensile modulus and notched impact resistance.

### 5G Base Station

The term “5G base station” is intended to denote a radio transmitter/receiver, including several antennas, used in a mobile telecommunications network in order to maintain the communication between the network and the mobile users through a radio link.

Due to its properties, said composition (C) can be desirably integrated into 5G base station components. At 5G communication frequencies, signal attenuation is more sensitive to Df and a low Df is able to manage signal attentuation in base station applications. In addition, a low CLTE is able to manage thermal expansion when in contact with metals. Good mechanical properties are particularly desired during processing and in the end-use parts on a 5G base station.

According to a preferred embodiment, said 5G base station components are antennas housings. Other components of a 5G base station of interest herein include, but are not limited to, radiators, oscillators and dielectrics.

The term “antenna” denotes a device used in the transmission and reception of electromagnetic waves. The term “radiator” denotes a discrete conductor radiating radio frequency (RF) energy in an antenna system. The term “oscillator” denotes an electronic circuit that produces a periodic, oscillating electronic signal, often a sine wave or a square wave, and converts direct current (DC) from a power supply to an alternating current (AC) signal. The term “dielectrics” denotes a piece of dielectric (nonconductive) material, usually ceramic, that is designed to function as a resonator for radio waves, generally in the microwave and millimeter wave bands.

The invention will now be described with reference to the following examples, whose purpose is merely illustrative and not intended to limit the scope of the invention.

### Experimental Section

Materials

Ryton® QA200N is a poly(phenylene sulphide) commercially available from Solvay Specialty Polymers USA.

CNG3PA-820 is a flat D-glass fiber commercially available from Nittobo.

CSG3PA-820 is a flat E-glass fiber commercially available from Nittobo.

Boron nitride of grade Boronid 51-SF has median particle size of around 3 μm and is commercially available from ESK.

Boron nitride of grade NX5 has median particle size of around 5 μm and is commercially available from Momentive.

Boron nitride of grade NX9 has median particle size of around 9 μm and is commercially available from Momentive.

Mistron Vapor powder is talc with median particle size of around 2 μm and is commercially available from Imerys Talc.

Barium sulphate of grade Sachtoperse HP has median particle size of around 0.2 μm and is commercially available from Huntsman.

Strontium titanate of grade 396141 with median particle size of around 1-2 μm and is commercially available from Sigma Aldrich.

### Methods

### Compounding

The compositions shown in tables 2 and 3 below were compounded using a Coperion® ZSK-26 co-rotating twin-screw extruder having an L/D ratio of 48:1 at 200 rpm and 13-18 kg/hr. Barrel temperature set points were 305° C. and the die temperature set points were 300° C.

Thirteen compositions C1 to C13 were formed. Compositions C1, C2, C4, C10 and C13 are counterexamples. To form compositions C1 to C7 (Table 1), glass fiber CSG3PA-820 (40 wt. %) was used. To form compositions C8 to C13 (Table 2) glass fiber CNG3PA-820 (40 wt. %) was used.

### Molding

Test specimens were injection molded from the compositions according to ASTM D3641 at a melt temperature of 300° C. to 350° C. and mold temperature of 135° C. to 150° C.

### Testing

Dielectric properties (Dk and DO were measured according to ASTM D2520 (2.4 GHz). Measurements were taken on machined samples of injection molded discs having dimensions of 2 inches by 3 inches by ⅛ inch.

Tensile properties (tensile strain at break, tensile stress at break, tensile modulus) were determined according to ASTM D638 using injection molded test specimens.

The notched Izod impact strength was determined by ASTM D256 using injection molded test specimens.

The heat deflection temperature (HDT) was determined by ASTM D648 at 66 psi using injection molded test specimens.

The coefficient of linear thermal expansion (CLTE) was determined by ASTM D696 using injection molded test specimens.

### Results

Table 2 shows the entire set of trials carried out with the specimens C1-07 comprising CSG3PA-820 (i.e. flat E-glass fiber). Table 3 shows the entire set of trials carried out with the specimens C8-C13 comprising CNG3PA-820 (i.e. flat D-glass fiber). As used herein, specimens labelled with “(#)” are counterexamples.

TABLE 2

| Specimen | C1 (#) | C2 (#) | C3 | C4 (#) | C5 | C6 | C7 |
|---|---|---|---|---|---|---|---|
| Polymer [wt. %] | Ryton ® | Ryton ® | Ryton ® | Ryton ® | Ryton ® | Ryton ® | Ryton ® |
| | QA200N | QA200N | QA200N | QA200N | QA200N | QA200N | QA200N |
| | (45 wt. %) | (45 wt. %) | (45 wt. %) | (45 wt. %) | (45 wt. %) | (45 wt. %) | (45 wt. %) |
| Glass fiber [wt. %] | CSG3PA- | CSG3PA- | CSG3PA- | CSG3PA- | CSG3PA- | CSG3PA- | CSG3PA- |
| | 820 | 820 | 820 | 820 | 820 | 820 | 820 |
| | (40 wt. %) | (40 wt. %) | (40 wt. %) | (40 wt. %) | (40 wt. %) | (40 wt. %) | (40 wt. %) |
| Additive [wt. %] | Strontium | Barium | Talc | Barium | Talc | NX5 | NX9 |
| | titanate | sulphate | (7 wt. %) | sulphate | (15 wt. %) | (15 wt. %) | (15 wt. %) |
| | (7 wt. %) | (7 wt. %) | | (15 wt. %) | | | |
| HDT [° C.] | 277 | 281 | 280 | 280 | 281 | 281 | 280 |
| Shrinkage in mold direction [%] | 0.269 | 0.242 | 0.254 | 0.226 | 0.219 | 0.217 | 0.285 |
| Shrinkage in transverse | 0.679 | 0.597 | 0.619 | 0.566 | 0.57 | 0.508 | 0.675 |
| direction [%] | | | | | | | |
| IZOD Notch impact [ft-lb/in] | 1.16 | 1.81 | 1.21 | 1.69 | 1.03 | 1.26 | 1.35 |
| Tensile stress at break [psi] | 21100 | 26200 | 23400 | 25400 | 21200 | 22300 | 21200 |
| Tensile strain at break [%] | 1.3 | 1.7 | 1.5 | 1.6 | 1.2 | 1.2 | 1.2 |
| Tensile modulus [ksi] | 2370 | 2480 | 2610 | 2710 | 3100 | 3010 | 2930 |
| Dk at 2.4 GHz | 4.36 | 4.17 | 4.14 | 4.4 | 4.31 | 4.42 | 4.3 |
| Df at 2.4 GHz | 0.0051 | 0.0053 | 0.0049 | 0.0057 | 0.0048 | 0.0048 | 0.005 |
| CLTE in mold direction | 14.43 | 13.34 | 13.18 | 12.92 | 11.29 | 11.82 | 13.12 |
| (0-80° C.) [um/(mC)] | | | | | | | |
| CLTE in transverse direction | 37.08 | 36.21 | 34.67 | 32.23 | 31.39 | 30.71 | 31.2 |
| (0-80° C.) [um/(mC)] | | | | | | | |

As evident from Table 2, specimens C3, C5, C6 and C7, which are object of the present invention, provide for a desirable combination of dielectric properties (i.e. low Dk and DO and CLTE in both directions while having excellent mechanical properties and low shrinkage in mold and transverse direction, with respect to specimens C1, C2 and C4. Although C2 shows good dielectric properties, especially in terms of Dk which is lower than that shown by C5, C6 and C7, its CLTE is much higher and therefore not satisfactory for applications in 5G base stations.

TABLE 3

| | C8 | C9 | C10 (#) | C11 | C12 | C13 (#) |
|---|---|---|---|---|---|---|
| Polymer [wt. %] | Ryton ® | Ryton ® | Ryton ® | Ryton ® | Ryton ® | Ryton ® |
| | QA200N | QA200N | QA200N | QA200N | QA200N | QA200N |
| | (45 wt. %) | (45 wt. %) | (45 wt. %) | (45 wt. %) | (45 wt. %) | (45 wt. %) |
| Glass fiber [wt. %] | CNG3PA- | CNG3PA- | CNG3PA- | CNG3PA- | CNG3PA- | CNG3PA- |
| | 820 | 820 | 820 | 820 | 820 | 820 |
| | (40 wt. %) | (40 wt. %) | (40 wt. %) | (40 wt. %) | (40 wt. %) | (40 wt. %) |
| Additive [wt. %] | Boronid | Talc | Barium | Boronid | Talc | Barium |
| | S1-SF | (7 wt. %) | sulphate | S1-SF | (15 wt. %) | sulphate |
| | (7 wt. %) | | (7 wt. %) | (15 wt. %) | | (15 wt. %) |
| HDT [° C.] | 279 | 279 | 279 | 280 | 280 | 279 |
| Shrinkage in mold direction [%] | 0.153 | 0.173 | 0.14 | 0.231 | 0.231 | 0.209 |
| Shrinkage in transverse | 0.401 | 0.41 | 0.391 | 0.404 | 0.404 | 0.493 |
| direction [%] | | | | | | |
| IZOD Notch impact [ft-lb/in] | 1.6 | 1.47 | 2.19 | 1.23 | 1.14 | 2.13 |
| Tensile stress at break [psi] | 24200 | 23900 | 27800 | 20600 | 20600 | 27600 |
| Tensile strain at break [%] | 1.7 | 1.6 | 2 | 1.2 | 1.2 | 2 |
| Tensile modulus [ksi] | 2390 | 2350 | 2170 | 2860 | 2690 | 2360 |
| Dk at 2.4 GHz | 3.82 | 3.75 | 3.80 | 3.97 | 3.94 | 3.96 |
| Df at 2.4 GHz | 0.0031 | 0.0032 | 0.0037 | 0.0029 | 0.0029 | 0.0038 |
| CLTE in mold direction | 13.87 | 15.23 | 15.96 | 12.33 | 11.67 | 15.23 |
| (0-80° C.) [um/(mC)] | | | | | | |
| CLTE in transverse direction | 32.97 | 33.05 | 34 | 27.63 | 27.32 | 33.38 |
| (0-80° C.) [um/(mC)] | | | | | | |

Referring to Table 3, specimens C8, C9, C11 and C12, which are object of the present invention, provide for a desirable combination of dielectric properties and CLTE in both directions while having excellent mechanical properties and low shrinkage in mold and transverse direction, in comparison with specimens C10 and C13.

From the above results, it is noted that specimens comprising a greater amount (15 wt. %) of Boronid S1-SF and talc provides better performances in terms of dielectric properties, like low Df, and CLTE than specimens comprising a lower amount thereof (7 wt. %).

Comparing the results reported in Tables 2 and 3, it is noted that specimens C8, C9, C11 and C12 comprising a flat D-glass fiber show significantly better dielectric properties (i.e. lower Dk and DO and much lower shrinkage in the transverse direction than specimens C3, C5, C6 and C7 comprising a flat E-glass fiber. It is also noted that the transverse CLTE in specimens C11 and C12 is much lower than specimens C3, C5, C6 and C7.

Should the disclosure of any patents, patent applications, and publications which are incorporated herein by reference conflict with the description of the present application to the extent that it may render a term unclear, the present description shall take precedence.

1. A composition (C) comprising:
a poly(arylene sulphide) polymer;
at least one flat glass fiber;
at least one of boron nitride and talc.

2. The composition (C) according to claim 1, wherein said poly(arylene sulphide) polymer is a poly(phenylene sulphide).

3. The composition (C) according to claim 1, comprising said poly(arylene sulphide) polymer in a concentration of at least 30 wt. %, with respect to the total weight of the composition (C).

4. The composition (C) according to claim 1, wherein said at least one flat glass fiber is a flat E-glass fiber.

5. The composition (C) according to claim 4, wherein said flat E-glass fiber has a dielectric constant (Dk) at 2.4 GHz ranging from 6.0 to 7.0, and/or said flat E-glass fiber has a dissipation factor (Df) at 2.4 GHz ranging from 0.003 to 0.004.

6. The composition (C) according to claim 1, wherein said at least one flat glass fiber is a flat D-glass fiber or a mixture of flat E-glass and D-glass fibers.

7. The composition (C) according to claim 6, wherein said flat D-glass fiber has a dielectric constant (Dk) at 2.4 GHz ranging from 4.0 to 5.0, and/or said flat D-glass fiber has a dissipation factor (Df) at 2.4 GHz not greater than 0.003.

8. The composition (C) according to claim 1, comprising said at least one flat glass fiber in a concentration of at least 10 wt. %, and/or of at most 50 wt. %, with respect to the total weight of the composition (C).

9. The composition (C) according to claim 1, comprising boron nitride having a median particle size of at least 0.05 μm, and/or of at most 30 μm.

10. The composition (C) according to claim 1, comprising talc having a median particle size of at least 0.05 μm, and/or of at most 30 μm.

11. The composition (C) according to claim 1, comprising boron nitride and/or talc in a concentration of at least 5 wt. %, and/or of at most 30 wt. %, with respect to the total weight of the composition (C).

12. The composition (C) according to claim 1, consisting essentially of:
the poly(arylene sulphide) polymer;
the at least one flat glass fiber;
the at least one of boron nitride and talc.

13. A 5G base station component comprising the composition (C) according to claim 1.

14. The 5G base station component according to claim 13, being an antenna housing.

15. The 5G base station component according to claim 13, being selected from the group consisting of radiators, oscillators and dielectrics.

16. The composition according to claim 6, wherein said flat E-glass fiber has a dielectric constant (Dk) at 2.4 GHz ranging from 6.0 to 7.0 and/or said flat E-glass fiber has a dissipation factor (Df) at 2.4 GHz ranging from 0.003 to 0.004.
